(19) United States
(12) Patent Application Publication
(10) Pub. No.: US 2019/0091907 A1
(43) Pub. Date: Mar. 28, 2019

(54) METHOD FOR PRODUCING RESIN MOLDED BODY

(71) Applicant: c/o Denso Corporation, Kariya-city, Aichi-perf. (JP)

(72) Inventors: Hodaka MORI, Kariya-city (JP); Ryosuke IZUMI, Kariya-city (JP); Hiroyuki YAMAKAWA, Kariya-city (JP); Motomi KUROKAWA, Kariya-city (JP); Norihito YOSHIDA, Kariya-city (JP)

(21) Appl. No.: 15/774,325

(22) PCT Filed: Nov. 4, 2016
(86) PCT No.: PCT/JP2016/082745

§ 371 Date: May 8, 2018

(51) Int. Cl. B29C 45/14

(52) U.S. Cl. CPC B29C 45/14336; B29K 2101/12

(57) ABSTRACT

In a method for producing a resin molded body, a thermosetting resin member is formed by heating a thermosetting resin material that is a raw material of the thermosetting resin member to complete a curing. A nascent surface having a functional group is formed on at least a part of a sealed surface of the thermosetting resin member by removing a surface layer that is an outermost layer of the sealed surface via irradiation of laser light to the sealed surface. The sealed surface of the thermosetting resin member is sealed with the thermoplastic resin member by injecting a thermoplastic resin material to the thermosetting resin member having the nascent surface, the functional group of the nascent surface being chemically bonded to the functional group of the additive. The thermosetting resin member has an absorption of the laser light at or above 10% per 1 μm.

### CROSS REFERENCE TO RELATED APPLICATION

This application is based on and incorporates herein by reference Japanese Patent Application No. 2015-225071 filed on Nov. 17, 2015.

### TECHNICAL FIELD

The present disclosure relates to a method for producing a resin molded body in which a sealed surface that is a surface of a thermosetting resin member is sealed with a thermoplastic resin member.

### BACKGROUND ART

Conventionally, a known resin molded body includes: a sealed member including a substrate on which components are mounted; a thermosetting resin member being made of thermosetting resin and sealing a surface of the sealed member; and a thermoplastic resin member being made of thermoplastic resin and sealing a surface of the thermosetting resin member (see Patent Document 1). In Patent Document 1, the thermoplastic resin member seals a part of the surface of the thermosetting resin member, and the other part of the surface is exposed from the thermoplastic resin member.

The thermosetting resin is preferable because it has a high adhesion to and a low stress on the sealed member, and the thermoplastic resin is preferable because it gives a high dimension accuracy and toughness to a product. For example, epoxy resin is used as the thermosetting resin, and PPS (polyphenylene sulfide) or PBT (polybutylene terephthalate) is used as the thermoplastic resin.

The resin molded body is generally produced as below. First, the sealed member is sealed with a thermosetting resin material that is a raw material of the thermosetting resin member, and the sealed member is heated to complete a curing of the thermosetting resin material. This process is a curing molding process, or a first molding.

Next, a plastic molding process, or a second molding is performed, in which a thermoplastic resin material that is a raw material of the thermoplastic resin member is injected to seal a sealed surface of the surface of the thermosetting resin member, and then the thermoplastic resin material is heated to form the thermoplastic resin member. The resin molded body is formed in this way.

### PRIOR ART DOCUMENT

### Patent Document

Patent Document 1: JP 3620184B2

### SUMMARY OF THE INVENTION

However, since the adhesion of the thermoplastic resin to the thermosetting resin is low, a separation of the thermosetting resin member and the thermoplastic resin member is likely to occur in an interface.

In the resin molded body of Patent Document 1, when a separation occurs in the interface, outside moisture or contaminations may enter the resin molded body along the interface through an end part that is a boundary of the sealed surface and the exposed surface of the thermosetting resin member.

In consideration of such problem regarding separation in the interface, according to the publication, additional filler material is provided in the end part that is a boundary of the sealed surface and the exposed surface to seal the end part of the interface and limit the separation of the interface. However, in this case, since the additional filler material is needed, the shape of the resin molded body may be limited, and the cost may increase.

The inventors of the present disclosure have considered a method for increasing adhesion between the sealed surface and the thermoplastic resin member by irradiation of laser light to the sealed surface of the thermosetting resin member. In this method, the sealed surface of the thermosetting resin member is irradiated with the laser first, and a surface layer that is an outermost layer of the sealed surface is removed to form a nascent surface having functional groups.

Subsequently, a thermoplastic resin material, which is a raw material of the thermoplastic resin member and contains an additive having functional groups configured to chemically bond to the functional groups on the nascent surface, is injected to the thermosetting resin member having the nascent surface. According to this, the functional groups of the nascent surface are chemically bonded to the functional groups of the additive in the thermoplastic resin material, and the sealed surface of the thermosetting resin member is sealed with the thermoplastic resin member.

According to this, contaminations on the sealed surface are removed to form the nascent surface in the interface between the sealed surface of the thermosetting resin member and the thermoplastic resin member sealing the sealed surface. The thermosetting resin member and the thermoplastic resin member are chemically bonded through the functional groups on the nascent surface. According to the chemical bonds, high adhesion between the thermosetting resin member and the thermoplastic resin member can be achieved. That is, the adhesion between the thermosetting resin member and the thermoplastic resin member can be improved.

However, according to this method, since the laser light penetrates an inside of the thermosetting resin as well as the surface of the thermosetting resin, the foundation layer, i.e. the non-removal part, is heated in addition to the surface layer of the sealed surface that is to be removed, and accordingly thermal stress may occur in the non-removal part. Especially, when the thermosetting resin member is constituted by a resin that is an organic material and an inorganic filler, difference in the coefficient of thermal expansion between the resin material and the inorganic filler may cause a large thermal stress during heating.

Accordingly, the inventors have found that hairline cracks may occur in the non-removal part when the surface processing is performed with the laser light as described above. Hereinafter, the cracks in the non-removal part are referred to as a processing damage. The processing damage spreads during molding the thermoplastic resin member and reliability tests, and accordingly the liability of the bonding part may decrease.

It is an objective of the present disclosure to limit effects of processing damage due to irradiation of laser light when the sealed surface of the thermosetting resin member sealed with the thermoplastic resin member is is irradiated with the laser light to improve adhesion between a sealed surface and a thermoplastic resin member.

According to an aspect of the present disclosure, a method is for producing a resin molded body including a thermosetting resin member made of a thermosetting resin and a thermoplastic resin member made of a thermoplastic resin. The thermoplastic resin member seals a sealed surface that is at least a part of a surface of the thermosetting resin member, and the method includes the following steps.

First, a the thermosetting resin member is formed by heating a thermosetting resin material to complete a curing of the thermosetting resin material. The thermosetting resin material is a raw material of the thermosetting resin member. A nascent surface having a functional group is formed on at least a part of the sealed surface by removing a surface layer that is an outermost layer of the sealed surface via irradiation of laser light to the sealed surface of the thermosetting resin member. A thermoplastic material that is a raw material of the thermoplastic resin member is injected to the thermosetting resin member having the nascent surface. The thermoplastic resin material contains an additive having a functional group capable of chemically bonding to the functional group of the nascent surface. Thus, the functional group of the nascent surface is bonded to the functional group of the additive, and the sealed surface of the thermosetting resin member is sealed with the thermoplastic resin member. The thermosetting resin member has an absorption of the laser light at or above 10% per 1 μm.

It is desirable that a crack occurring in the sealed surface of the thermosetting resin member does not extend to a deep part of a non-removal part. That is, it is desirable that the crack in the non-removal part is stopped in a shallow part. The lower the laser absorption of the thermosetting resin member is, the deeper an absorption depth of the laser light is, i.e. the deeper a part in which a thermal stress causing the crack may occur is.

In contrast, in the producing method of the present aspect, since the laser absorption of the thermosetting resin member is at or above 10% per 1 μm, the depth of the part in which a thermal stress may occur in the non-removal part can be limited. Accordingly, effects of a processing damage on the thermosetting resin member due to the laser irradiation can be limited.

### BRIEF DESCRIPTION OF THE DRAWINGS

FIG. 1 is a cross-sectional diagram illustrating a semiconductor device that is a resin molded body according to an embodiment of the present disclosure.

FIG. 2 is a diagram illustrating an R part of FIG. 1, which is a part of the cross-section of the semiconductor device during a producing process.

FIG. 3 is a diagram illustrating the R part of FIG. 1, which is a part of the cross-section after FIG. 2.

FIG. 4 is a diagram illustrating the R part of FIG. 1, which is a part of the cross-section after FIG. 3.

FIG. 5 is a diagram illustrating the R part of FIG. 1, which is a part of the cross-section after FIG. 4.

FIG. 6 is a graph illustrating results of simulations by the inventors of the present disclosure based on Beer-Lambert law, and the graph shows relationships between laser intensity and laser absorption depth in thermosetting resins having different laser light absorption.

FIG. 7 is a diagram illustrating relationships between a wavelength of laser and the laser absorption depth of a typical thermosetting resin.

FIG. 8 is a diagram illustrating relationships between a wavelength of laser and a transmittance of carbon black that is a colorant.

### EMBODIMENTS FOR EXPLOITATION OF THE INVENTION

Hereinafter, an embodiment of the present disclosure will be described referring to drawings. In the drawings, the same reference numerals are assigned to the same or similar parts for simplifying descriptions.

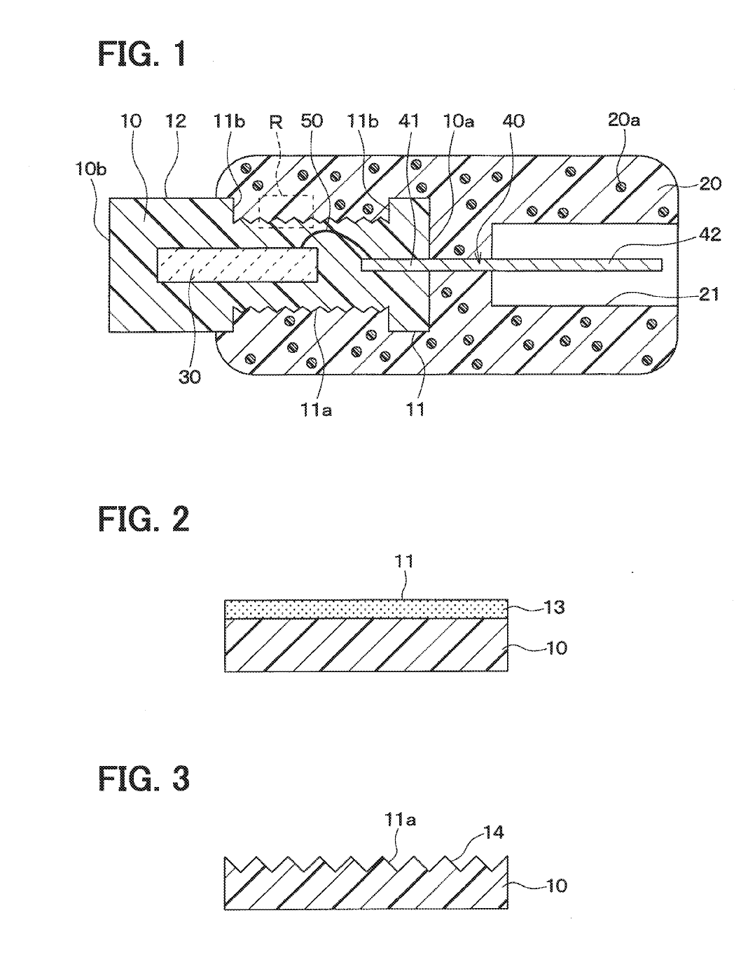

A resin molded body according to an embodiment of the present disclosure will be described with reference to FIG. 1. In FIG. 1, unevenness of a roughened surface 11a formed on a surface of a thermosetting resin member 10 and a height of stair 11b are enlarged by deformation for clarification.

The resin molded body is, for example, used as a semiconductor device mounted on a vehicle such as an automotive for actuating electronic devices for the vehicle. The semiconductor device that is the resin molded body of the present embodiment includes the thermosetting resin member 10 and a thermoplastic resin member 20 that seals a part of a surface of the thermosetting resin member 10.

The thermosetting resin member 10 is made of a thermosetting resin such as epoxy resin. The thermosetting resin member 10 is typically made of a thermosetting resin containing a colorant such as carbon black as in a general mold resin. The thermosetting resin typically contains a filler including an insulating inorganic material such as silica and alumina.

The thermosetting resin member 10 is made by molding such as transfer molding, compression, and potting, for example, and heat curing.

The thermoplastic resin member 20 is made of a thermoplastic resin such as PPS (polyphenylene sulfide) and PBT (polybutylene terephthalate). The thermoplastic resin member 20 is formed by injection molding to seal a part of the thermosetting resin member 10.

The thermoplastic resin member 20 contains an additive 20a. The additive 20a is made of polymer with one or some of hydroxyl group, epoxy group, amino group, and carbonyl group, for example. The additive 20a chemically reacts with functional groups on the roughened surface 11a of the thermosetting resin member 10 to achieve a high adhesion with thermosetting resin-thermoplastic resin bonding.

Since the thermoplastic resin member 20 containing the additive 20a seals a part of the surface of the thermosetting resin member 10, the part of the surface of the thermosetting resin member 10 is called a sealed surface 11 sealed with the thermoplastic resin member 20. The other part of the surface of the thermosetting resin member 10 other than the sealed surface 11 is an exposed surface 12 that is exposed from the thermoplastic resin member 20.

As shown in FIG. 1, a part of the surface of the thermosetting resin member 10 on one end 10a in a lengthwise direction of the thermosetting resin member 10 is the sealed surface 11, and the other part of the surface of the thermosetting resin member 10 on the other end 10b in the lengthwise direction is the exposed surface 12.

The thermosetting resin member 10 includes therein a semiconductor element 30 that is a first sealed member sealed with the thermosetting resin member 10, and an electric connection member 40 that is a second sealed member.

The semiconductor member 30 that is the first sealed member is a sensor chip constituted by a silicon semiconductor used for a magnetic sensor, a light sensor, or a pressure sensor. The semiconductor element 30 is made by a general semiconductor processing.

For example, in the semiconductor element 30 for a magnetic sensor, a whole part of the semiconductor element 30 is sealed with the thermosetting resin member 10, and the semiconductor element 30 is configured to detect outside magnetism through the thermosetting resin member 10.

In the semiconductor element 30 for a light sensor or a pressure sensor, an opening portion through which a part of the semiconductor element 30 is exposed is provided in the thermosetting resin member 10, and the semiconductor element 30 is configured to detect light or pressure through the opening portion.

The electric connection member 40 that is the second sealed member is configured to connect the semiconductor element 30 with a wiring member outside the semiconductor device. A part 41 of the electric connection member 40 is sealed with the thermosetting resin member 10, arid the other part 42 protrudes from the sealed surface 11 of the thermosetting resin member 10. The other part 42 of the electric connection member 40 is sealed with the thermoplastic resin member 20 outside the thermosetting resin member 10, and a tip of the other part 42 is exposed from the thermoplastic resin member 20.

The part 41 of the electric connection member 40 is electrically connected with the semiconductor element 30 in the thermosetting resin member 10. Although the connection method between the part 41 and the semiconductor element 30 is not limited to a particular method, the part 41 is connected with the semiconductor element 30 through a bonding wire 50 made of Al or Au in the present embodiment.

The thermoplastic resin member 20 seals the other part 42 of the electric connection member 40, and an opening portion 21 is provided in the thermoplastic resin member 20. A part of the other part 42 of the electric connection member 40 is exposed to an outside of the thermoplastic resin member 20 through the opening portion 21.

An outside wiring member, which is not shown, such as a connector member is inserted into the opening portion 21 of the thermoplastic resin member 20, and the wiring member is electrically connected with the electric connection member 40.

The electric connection member 40 functions as a part of the semiconductor element 30 for detection or output, and the semiconductor element 30 is configured to electrically communicate with outside of the device through the electric connection member 40. A stick terminal made of Cu or Al is used as the electric connection member 40 in the present embodiment. A circuit board may be used as the electric connection member 40.

In the semiconductor device of the present embodiment, a part of the sealed surface 11 of the thermosetting resin member 10 is the roughened surface 11a. The roughened surface 11a is formed through a surface layer removal process in a producing method described later. A degree of roughness of the roughened surface 11a is larger than that of the sealed surface 11 and the exposed surface 12 other than the roughened surface 11a.

As described above, the other part 42 of the electric connection member 40 that is the second sealed member protrudes from the sealed surface 11 of the thermosetting resin member 10 and is sealed with the thermoplastic resin member 20.

In the present embodiment, the roughened surface 11a is provided only in the sealed surface 11 of the thermosetting resin member 10, i,e. inside of the thermoplastic resin member 20. That is, an end of the roughened surface 11a is inside the thermoplastic resin member 20.

As described above, the roughened surface 11a is formed by thoroughly removing a surface layer 13 of the sealed surface 11 (see FIG. 3). The stair 11b is provided such that the roughened surface 11a is recessed from a part of the surface of the thermosetting resin member 10 other than the roughened surface 11a. The height of the stair 11b is at or above a few μm (for example, 5 μm).

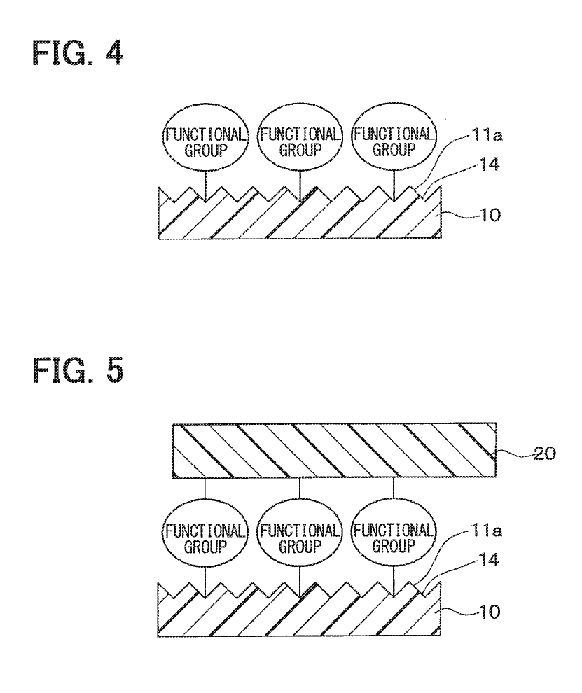

Next, a method for producing the semiconductor device of the present embodiment will be described with reference to FIG. 2 through FIG. 5. First, in a curing molding process shown in FIG. 2, the thermosetting resin member 10 is formed by heating to complete a curing of a thermosetting resin material that is a raw material of the thermosetting resin member 10.

Specifically, in the curing molding process, the semiconductor element 30 and the electric connection member 40 connected by the bonding wire 50 are sealed by transfer molding, compression, or potting, for example, and are heated to cure. The thermosetting resin member 10 is provided through such process.

After the curing molding process, the surface layer 13 constituted by contaminations is provided as an outermost surface of the thermosetting resin member 10. The contaminations are contained in materials of the thermosetting resin member 10, and moves to the outermost surface during the heating. After heating, the contaminations are rarely in inner layers inside the outermost layer. The contaminations may be a release agent or a foreign material that adheres on the surface of the thermosetting resin member 10 during processing. The release agent is applied to surfaces of a die or mixed in the thermosetting resin material for securing a high removability. The release agent contains siloxane or fatty acid, for example.

Subsequently, a surface layer removal process is performed to the thermosetting resin member 10, as shown in FIG. 3. In this process, a nascent surface 14 is formed by removing the outermost surface layer 13 from a part of the sealed surface 11 of the thermosetting resin member 10, i.e. a part of the sealed surface 11 where the roughened surface 11a is to be formed.

Specifically, the surface layer 13 is removed by irradiation of laser light to a target portion of the sealed surface 11 where the roughened surface 11a is to be formed. The laser light cuts a process surface to form unevenness. Any removal depth of the sealed surface 11 that is to be the roughened surface 11a is acceptable as long as the surface layer 13 is removed, i.e. at or above a few μm (for example, 5 μm).

The laser irradiance removes the surface layer 13 that contains contaminations and roughens the nascent surface 14 that is a foundation layer of the surface layer 13. As a result, the nascent surface 14 becomes the roughened surface 11a that has an anchor effect and good adhesion to the thermoplastic resin member 20. The nascent surface 14, i.e. the roughened surface 11a, includes one or some of hydroxyl group and epoxy group, for example, of the thermosetting resin that constitutes the thermosetting resin member 10.

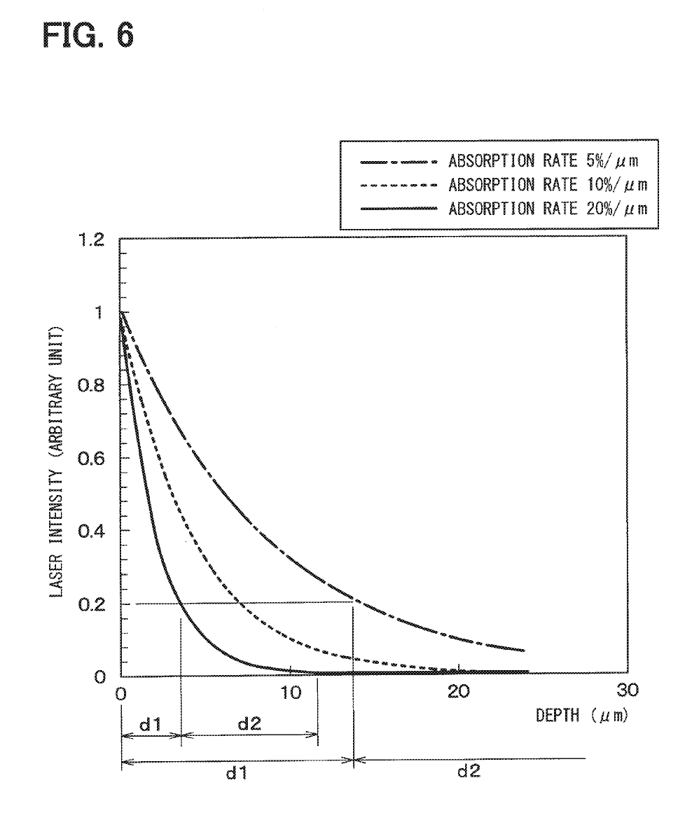

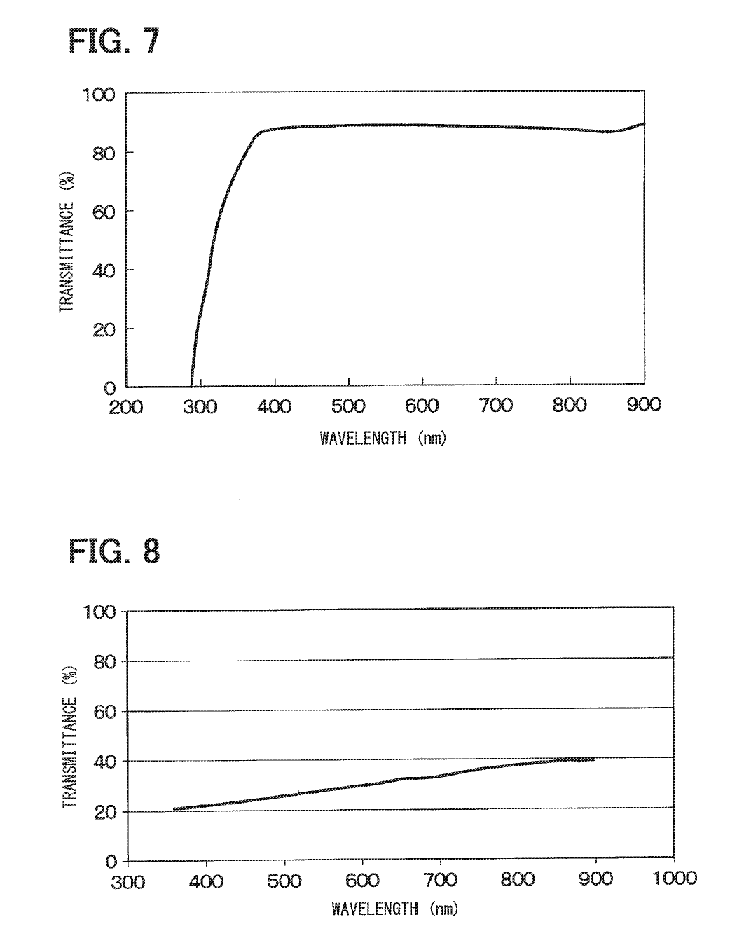

After the surface layer removal process, a plastic molding process shown in FIG. 5 is performed. In this step, a thermoplastic resin material containing the additive 20a is injected to mold the thermoplastic resin member 20 on the nascent surface 14 of the thermosetting resin member 10 having the functional groups. The thermoplastic resin material is a raw material of the thermoplastic resin member 20.

For example, the thermoplastic resin material containing the additive 20a can be provided by mixing a thermoplastic resin material, which is a base material, with the polymer that is the additive 20a having functional groups. The functional groups on the nascent surface 14 are chemically bonded to the functional groups in the additive 20a contained in the thermoplastic resin material, and accordingly the sealed surface 11 of the thermosetting resin member 10 is sealed with the thermoplastic resin member 20.

When the thermosetting resin member 10 is epoxy resin, hydroxyl groups or epoxy groups in the epoxy resin are chemically bonded to hydroxyl groups, epoxy groups, amino groups, or carbonyl groups in the additive 20a, in the plastic molding process. Since the chemical bond between hydroxyl groups or epoxy groups is covalent bond, the connection is strong. When the additive 20a contains at least one same functional group contained in the thermosetting resin member 10, covalent bond can be achieved.

The chemical bond achieves good adhesion between the thermoplastic resin member 20 and the nascent surface 14 (i.e. the roughened surface 11a) of the thermosetting resin member 10. Accordingly, the semiconductor device that is the resin molded body of the present embodiment can be produced.

In the above-described processes after the surface layer forming process, a part of the surface of the thermosetting resin member 10 is selectively processed. Accordingly, the other part of the surface is masked during the processes.

According to the above-described producing method, the contaminations are removed to form the nascent surface 14 as an interface between the sealed surface 11 of the thermosetting resin member 10 and the thermoplastic resin member 20 that seals the sealed surface 11. The thermosetting resin member 10 and the sealed surface 11 are chemically bonded on the nascent surface 14 through the functional groups.

The chemical bonds achieve good adhesion between the thermosetting resin member 10 and the thermoplastic resin member 20. That is, the adhesion between the thermosetting resin member 10 and the thermoplastic resin member 20 can be improved according to the present embodiment.

In the producing method according to the present embodiment, the thermosetting resin member 10 has a laser absorption late in the surface layer removal process at or above 10 percent. This is for limiting a processing damage of the thermosetting resin member 10 due to the laser irradiation as much as possible. The reason of 10 percent will be described below.

Generally, relationships between a type and thickness of substance and intensity of light irradiation to the substance are described by Beer-Lambert law. According to the law, a penetration depth is dependent on the absorption of the substance. The higher the absorption is, the exponentially smaller the penetration depth is. That is, when the surface processing of the substance is performed in a condition where the absorption is low, the light intensity decreases slowly, and accordingly much energy may be absorbed by a part that is not to be processed.

In FIG. 6, the vertical line represents the laser intensity in arbitrary unit, and the horizontal line represents the depth in μm. The depth means how deep the laser light penetrates from the surface of the thermosetting resin, i.e. laser absorption depth. In FIG. 6, three cases are shown. In each case, the laser light absorption late of the thermosetting resin is 5%, 10%, and 20% per laser absorption depth of 1 μm, respectively. As shown in FIG. 6, the higher the laser light absorption of the thermosetting resin is, the exponentially smaller than the laser absorption depth is.

According to this simulation, the lower limit of removal depth of the thermosetting resin is at laser intensity of 0.2. That is, when the laser light absorption is 20%, the thermosetting resin is removed within the depth range of d1. However, the thermosetting resin is not removed within the depth range of d2, and thermal stress occurs to cause processing damages. Hereinafter, d1 is referred to as a removal depth d1, and d2 is referred to as a processing damage depth d2.

As shown in FIG. 6, when the laser light absorption is 20% or 10% per 1 μm, the processing damage depth d2 is finite range. However, when the laser light absorption is 5%, the processing damage depth d2 is significantly larger than the removal depth d1 and is substantially infinite range. This means that the processing damage spreads throughout the thermosetting resin member 10.

According to the producing method of the present embodiment, when the thermosetting resin member 10, whose absorption of the laser used for the laser irradiation is at or above 10% per 1 μm, is used, the depth in which the thermal stress occurs in a part that is not removed is finite. Accordingly, the occurrence of the processing damage can be limited to a shallow portion, and effects of the processing damage on the thermosetting resin member 10 due to the laser irradiation can be limited.

When a wavelength is at or below 400 nm, the laser light absorption of epoxy resins that is a typical thermosetting resin is at or above 10% per 1 μm, i.e. the laser transmittance is at or below 90%. Accordingly, the wavelength of the laser light used in the surface layer removal process is at or below 400 nm.

Specifically, compared to long-wavelength lasers (1064 nm) such as Nd:YAG and YVO4 which are generally used, short-wavelength lasers (351-193 nm) such as harmonic lasers of those and excimer laser can be effectively absorbed. Such lasers are effective even when the thermosetting resin constituting the thermosetting resin member 10 contains colorant such as carbon black.

The colorant is used for protecting sealed parts inside the resin. Carbon black, for example, has a slightly high absorption within a short-wavelength range as shown in FIG. 8, but absorbs laser light uniformly. Since typical colorants of this kind have similar absorption characteristics, the laser with wavelength at or below 400 nm is preferable.

In the above-described embodiment, the roughened surface 11a to which laser light is irradiated, i.e. the nascent surface 14, is a part of the sealed surface 11 of the thermosetting resin member 10, but the nascent surface 14 may be provided on whole part of the sealed surface 11.

The colorant is not limited to carbon black, and any colorant is acceptable as long as it is contained in this kind of the thermosetting resin member 10. The thermosetting resin member 10 may not contain colorant and inorganic filler.

Any devices are acceptable as the first sealed member and the second sealed member as long as it can be sealed with the thermosetting resin member 10. The first sealed member and the second sealed member are not limited to the semiconductor element 30, the electric connection member 40, and the circuit board.

In the above-described embodiment, the resin molded body is a semiconductor device, and sealed members such as the semiconductor element 30 are sealed with the thermosetting resin member 10. However, the resin molded body is not limited to the semiconductor device, and the thermosetting resin member 10 may not include sealed members.

In the above-described embodiment, the sealed surface 11 of the thermosetting resin member 10 is a part of the surface of the thermosetting resin member 10, and the other part of the surface of the thermosetting resin member 10 is the exposed surface 12. However, the whole part of the thermosetting resin member 10 may be the sealed surface 11 and sealed with the thermoplastic resin member 20. In this case also, the above-described producing method can be used.

the above-described embodiment is not limited to the examples shown in the drawings.

Although the present disclosure has been fully described in connection with the embodiment thereof, it is to be noted that various changes and modifications will become apparent to those skilled in the art. Moreover, other combinations and configurations, including more, less or only a single element, are also within the spirit and scope of the present disclosure.

What is claimed is:

1. A method for producing a resin molded body, the resin molded body including a thermosetting resin member made of thermosetting resin and a thermoplastic resin member made of a thermoplastic resin, the thermoplastic resin member sealing a sealed surface that is at least a part of a surface of the thermosetting resin member, the method comprising:
forming the thermosetting resin member by heating a thermosetting resin material that is a raw material of the thermosetting resin member to complete a curing of the thermosetting resin material;
forming a nascent surface having a functional group on at least a part of the sealed surface by removing a surface layer that is an outermost layer of the sealed surface via irradiation of laser light to the sealed surface of the thermosetting resin member; and
sealing the sealed surface of the thermosetting resin member with the thermoplastic resin member and chemically bonding the functional group of the nascent surface to a functional group of an additive contained in the thermoplastic resin member by injecting a thermoplastic resin material to the thermosetting resin member having the nascent surface, the thermoplastic resin material being a raw material of the thermoplastic resin member and containing the additive having the functional group capable of chemically bonding to the functional group of the nascent surface, wherein
the thermosetting resin member has an absorption of the laser light at or above 10% per 1 μm.

2. The method for producing the resin molded body according to claim 1, wherein
a wavelength of the laser light is at or below 400 nm.

3. The method for producing the resin molded body according to claim 1, wherein
the thermosetting resin member is made of epoxy resin containing a colorant.

4. The method for producing the resin molded body according to claim 3, wherein
the colorant is carbon black.

5. The method for producing the resin molded body according to claim 1, wherein
the thermosetting resin member is made of the thermosetting resin containing an inorganic filler.
